(19) United States
(12) Patent Application Publication
(10) Pub. No.: US 2007/0013765 A1
(43) Pub. Date: Jan. 18, 2007

(54) Flexible organic laser printer

(75) Inventors: Nicolas H. Hudson, Halswell (NZ); Richard W. Wien, Pittsford, NY (US); David L. Patton, Webster, NY (US); Keith B. Kahen, Rochester, NY (US); Thomas M. Stephany, Churchville, NY (US); James G. Chase, Christchurch (NZ)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/183,488

(22) Filed: Jul. 18, 2005

(51) Int. Cl. B41J 2/45

(52) U.S. Cl. 347/238

(57) ABSTRACT

A printing device and method for printing. The printing device includes photoconductor for receiving a charge, a plurality of organic vertical cavity surface emitting lasers for producing a charged image pattern on said photoconductor; a toner application mechanism for applying a toner onto said photoconductor for creating a toner image pattern in accordance with said charged image pattern; and a transfer mechanism for transferring said toner image pattern onto a media.

### FIELD OF THE INVENTION

The invention relates generally to the field of Vertical Cavity Surface Emitting Lasers (VCSELs) or microcavity lasers, and in particular to organic microcavity lasers or organic VCSELS. More specifically, the invention relates to the various flexible arrays of organic laser cavities used as printing engines.

### BACKGROUND OF THE INVENTION

Laser printers rely on the same technology used first in photocopying machines. This process is known as electro photography and was invented in 1938 and developed by Xerox and Eastman Kodak in the later 1980s. Prior art laser printer 3 rely on a laser beam 4 and scanner assembly 5 to form a latent image on a photo-conductor 11, wrapped around a drum, bit by bit. The scanning process, as illustrated in FIG. 1, is similar to electron beam scanning used in CRT. The laser 6 produces the beam 4 modulated by electrical signals from the printer's controller (not shown) is directed through a collimator lens 7 and mirror 8 onto a rotating polygon mirror (scanner) 9, which reflects the laser beam 4. Then reflected from the scanner 9, the laser beam 4 passes through a scanning lens system 10, which makes a number of corrections to it and scans on the photo-conductor (drum) 11.

The core component of this system is the photo-conductor 11 or photoreceptor, typically a revolving drum or cylinder. This drum assembly is made out of highly photoconductive material that is discharged by light photons.

Initially, the drum 11 is given a total positive charge by the charge corona wire 12, a wire with an electrical current running through it. (Some printers use a charged roller instead of a corona wire, but the principle is the same.) As the drum 11 revolves, the printer shines a tiny laser beam 4 across the surface to discharge certain points. In this way, the laser 6 “draws” the letters and images to be printed as a pattern 13 of electrical charges—an electrostatic image. The system can also work with the charges reversed—that is, a positive electrostatic image on a negative background.

After the pattern 13 is set, the printer 3 coats the drum 11 with positively charged toner (not shown)—a fine, black powder. Since it has a positive charge, the toner clings to the negative discharged areas of the drum 11, but not to the positively charged “background”.

With the powder pattern affixed, the drum rolls over a sheet of paper 14, which is moving along a belt 15 below. Before the paper rolls under the drum, it is given a negative charge by the transfer corona wire 16 (charged roller). This charge is stronger than the negative charge of the electrostatic image, so the paper 14 can pull the toner powder away. Since it is moving at the same speed as the drum 11, the paper 14 picks up the image pattern 18 exactly. To keep the paper from clinging to the drum 11, the paper 14 is discharged by the detach corona wire 17 immediately after picking up the toner. Material other than paper such as plastic etc. can be printed using this device.

Finally, the printer 3 passes the paper 14 through the fuser 19, a pair of heated rollers. As the paper 14 passes through these rollers, the loose toner powder melts, fusing with the fibers in the paper. The fuser rolls the paper to the output, and you have your finished page.

After depositing toner on the paper, the surface of the drum 11 passes the discharge lamp 20. This bright light exposes the entire photoreceptor surface, erasing the electrical image. The drum surface 11 then passes the charge corona wire 12, which reapplies the positive charge.

The most expensive part of the printer described above is the write laser and associated optics, which need to be precision ground and extremely accurate. This is generally the limiting factor in output resolution. There are laser printers capable of 2400 dpi and over, but most are 600 dpi.

LED arrays provide an alternative to lasers as the writing source. While LED arrays are somewhat simpler in design and do not need the rotating mirror, the arrays are expensive to assemble and difficult to align with the photoconductor to achieve the registration necessary for printing. In addition the light from the LED arrays spreads out a great deal more then the light from lasers requiring the LED arrays to be placed in close proximity to the photoconductor. The spaced requirements in electro-photographic printers around the photoconductors is very limited and any writing light source which can be conveniently spaced away from the photoconductor without requiring a complicated optical path provides a definite advantage.

One solution provided by the present invention to the problem stated above is to replace the laser and expensive reflective optics with an array of organic vertical cavity surface emitting lasers (VCSELs) lasers. The array would be cheaper to produce, give faster output times, greater resolution and can be placed further from the photoconductor.

Vertical cavity surface emitting lasers (VCSELs) based on inorganic semiconductors (e.g. AlGaAs) have been developed since the mid-80's (Kinoshita et al., IEEE Journal of Quantum Electronics, Vol. QE-23, No. 6, June 1987). They have reached the point where AlGaAs-based VCSELs emitting at 850 nm are manufactured by a number of companies and have lifetimes beyond 100 years (Choquette et al., Proceedings of the IEEE, Vol. 85, No. 11, November 1997). With the success of these near-infrared lasers, attention in recent years has turned to other inorganic material systems to produce VCSELs emitting in the visible wavelength range (Wilmsen, Vertical-Cavity Surface-Emitting Lasers, Cambridge University Press, Cambridge, 2001). There are many potential applications for visible lasers, such as, display, optical storage reading/writing, laser printing, and short-haul telecommunications employing plastic optical fibers (Ishigure et al., Electronics Letters, 16^{th} Mar. 1995, Vol. 31, No. 6). In spite of the worldwide efforts of many industrial and academic laboratories, much work remains to be done to create viable laser diodes (either edge emitters or VCSELs) that produce light output that spans the visible spectrum.

In an effort to produce visible wavelength VCSELs it would be advantageous to abandon inorganic-based systems and focus on organic-based laser systems, since organic-based gain materials can enjoy a number of advantages over inorganic-based gain materials in the visible spectrum. For example, typical organic-based gain materials have the properties of low unpumped scattering/absorption losses and high quantum efficiencies. In comparison to inorganic laser systems, organic lasers are relatively inexpensive to manufacture, can be made to emit over the entire visible range, can be scaled to arbitrary size and, most importantly, are able to emit multiple wavelengths (such as red, green, and blue) from a single chip. Over the past number of years, there has been increasing interest in making organic-based solid-state lasers. The laser gain material has been either polymeric or small molecule and a number of different resonant cavity structures were employed, such as, microcavity (Kozlov et al., U.S. Pat. No. 6,160,828, issued Dec. 12, 2000), waveguide, ring micro lasers, and distributed feedback (see also, for instance, Kranzelbinder et al., Rep. Prog. Phys. 63, (2000) 729-762 and Diaz-Garcia et al., U.S. Pat. No. 5,881,083, issued Mar. 9, 1999). A problem with all of these structures is that in order to achieve lasing it was necessary to excite the cavities by optical pumping using another laser source. It is much preferred to electrically pump the laser cavities since this generally results in more compact and easier to modulate structures.

A main barrier to achieving electrically pumped organic lasers is the small carrier mobility of organic material, which is typically on the order of 10⁻⁵ cm²/(V−s). This low carrier mobility results in a number of problems. Devices with low carrier mobilities are typically restricted to using thin layers in order to avoid large voltage drops and ohmic heating. These thin layers result in the lasing mode penetrating into the lossy cathode and anode, which causes a large increase in the lasing threshold (Kozlov et al., Journal of Applied Physics, Volume 84, No. 8, Oct. 15, 1998). Since electron-hole recombination in organic materials is governed by Langevin recombination (whose rate scales as the carrier mobility), low carrier mobilities result in orders of magnitude having more charge carriers than singlet excitons; one of the consequences of this is that charge-induced (polaron) absorption can become a significant loss mechanism (Tessler et al., Applied Physics Letters, Volume 74, Number 19, May 10, 1999). Assuming laser devices have a 5% internal quantum efficiency, using the lowest reported lasing threshold to date of ˜100 W/cm² (Berggren et al., Letters to Nature, Volume 389, page 466, Oct. 2, 1997), and ignoring the above mentioned loss mechanisms, would put a lower limit on the electrically-pumped lasing threshold of 1000 A/cm². Including these loss mechanisms would place the lasing threshold well above 1000 A/cm², which to date is the highest reported current density, which can be supported by organic devices (Tessler, Advanced Materials, 1998, 10, No. 1, page 64).

An alternative to electrical pumping for organic lasers is optical pumping by incoherent light sources, such as, light emitting diodes (LEDs), either inorganic (McGehee et al., Applied Physics Letters, Volume 72, Number 13, Mar. 30, 1998) or organic (Berggren et al., U.S. Pat. No. 5,881,089, issued Mar. 9, 1999). This possibility is the result of unpumped organic laser systems having greatly reduced combined scattering and absorption losses (˜0.5 cm⁻¹) at the lasing wavelength, especially when one employs a host-dopant combination as the active media. Even taking advantage of these small losses, the smallest reported optically pumped threshold for organic lasers to date is 100 W/cm² based on a waveguide laser design (Berggren et al., Letters to Nature Volume 389, Oct. 2, 1997). Since off-the-shelf inorganic LEDs can only provide up to ˜20 W/cm² of power density, it is necessary to take a different route to avail of optically pumping by incoherent sources. Additionally, in order to lower the lasing threshold it is necessary to choose a laser structure that minimizes the gain volume; a VCSEL-based microcavity laser satisfies this criterion. Using VCSEL-based organic laser cavities should enable optically pumped power density thresholds below 5 W/cm². As a result practical organic laser devices can be driven by optically pumping with a variety of readily available, incoherent light sources, such as LEDs.

One of the advantages of organic-based lasers is that since the gain material is typically amorphous, devices can be formed inexpensively when compared to lasers with gain materials that require a high degree of crystallinity (either inorganic or organic materials). Additionally, lasers based upon organic amorphous gain materials can be fabricated over large areas without regard to producing large regions of single crystalline material; as a result they can be scaled to arbitrary size resulting in greater output powers. Because of their amorphous nature, organic-based lasers can be grown on a wide variety of substrates; thus, materials such as glass, flexible plastics, and Si are possible supports for these devices. Thus, there can be significant cost advantages as well as a greater choice in usable support materials for amorphous organic-based lasers.

### SUMMARY OF THE INVENTION

In accordance with one aspect of said present invention there is provided a printing device, comprising:

a photoconductor for receiving a charge;

a plurality of organic vertical cavity surface emitting lasers for producing a charged image pattern on said photoconductor;

a toner application mechanism for applying a toner onto said photoconductor for creating a toner image pattern in accordance with said charged image pattern; and

a transfer mechanism for transferring said toner image pattern onto a media.

In accordance with anther aspect of said present invention there is provided a method for printing an image onto a media, comprising said steps of:

producing a charged image pattern on a photoconductor using said plurality of organic vertical cavity surface emitting lasers;

applying a toner onto said photoconductor for creating a toner image pattern in accordance with said charged image pattern; and

transferring said toner image pattern onto a media.

In accordance with yet another aspect of said present invention there is provided a method for writing an image onto a media, comprising said steps of:

providing a media on which an image is to be created; and

creating said image using a plurality of organic vertical cavity surface emitting lasers.

In accordance with still another aspect of said present invention there is provided a flexible writing head for writing onto photoconductor, comprising:

a flexible substrate having a plurality of organic vertical cavity surface emitting lasers arranged in pattern for producing images on said media.

In accordance with another aspect of the present invention there is provided a printer for printing onto a media, comprising:

a photoconductor for receiving a charge;

a flexible substrate having a plurality of organic vertical cavity surface emitting lasers provided in an arrangement for producing a charged image pattern on said photoconductor;

a toner application mechanism for applying a toner onto said photoconductor for creating a toner image pattern in accordance with said charged image pattern; and

a transfer mechanism for transferring said toner image pattern onto a media.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a schematic illustrating the electro photographic process used in a laser printer;

FIG. 2 is a cross-section side view schematic of an optically pumped organic laser cavity device;

FIG. 3 is a cross-section side view schematic of an optically pumped organic-based vertical cavity laser with a periodically structured organic gain region;

FIGS. 4A and B show an organic laser cavity structure made in accordance with the present invention in which a one-dimensional or linear arrangement of organic laser cavity devices is depicted and in which the spatial relationship between organic laser cavity devices is depicted;

FIG. 5 shows an organic laser cavity structure made in accordance with the present invention in which a two-dimensional arrangement of organic laser cavity devices is depicted;

FIG. 6 is a top view schematic of an organic laser cavity structure made in accordance with the present invention in which a two-dimensional hexagonal arrangement of organic lasers cavity devices is depicted;

FIG. 7 depicts an organic laser cavity structure in which sub-arrays of different wavelength organic laser cavity devices are fabricated;

FIG. 8 shows an organic laser cavity structure made in accordance with the present invention in which the structure is fabricated on a flexible support;

FIG. 9 is a schematic of a laser printer comprising an organic laser printer array made in accordance with the present invention;

FIG. 10 shows an organic laser cavity structure of FIG. 8 made in accordance with the present invention in which a uniform light source from a plurality of LEDs illuminates the organic laser cavity;

FIGS. 11A and B show the organic laser cavity structure of FIG. 8 made in accordance with the present invention in which a uniform light source from an integrating bar and a light valve respectively illuminates the organic laser cavity;

FIG. 12 is a schematic of another embodiment of the present invention; and

FIG. 13 is yet another embodiment of the present invention.

### DETAILED DESCRIPTION OF THE INVENTION

In a typical prior art electro-photographic printer using the laser printer the most expensive parts are the write laser and its associated optics. This is also generally the limiting factor in output resolution. This is also true in the case where the LED array is used as the printer because of the LED array's complicated assembly and alignment process.

Instead of using the laser and expensive reflective optics or the LED array and it's complicated assembly it is advantageous to replace these two components with an array of organic lasers. Organic based lasers can be fabricated over large areas and grown on a variety of substrates such as glass, Silica and most importantly flexible plastics. Organic lasers can be available in a broad range of wavelengths allowing optimization with photoconductive material. Print heads made from organic laser arrays will be cheaper to produce with faster output times and higher resolution.

In the present invention, the terminology describing vertical cavity organic laser devices (VCSELs) may be used interchangeably in a short hand fashion as “organic laser cavity devices.” Organic laser cavity structures are fabricated as large area structures and optically pumped with light emitting diodes (LEDs).

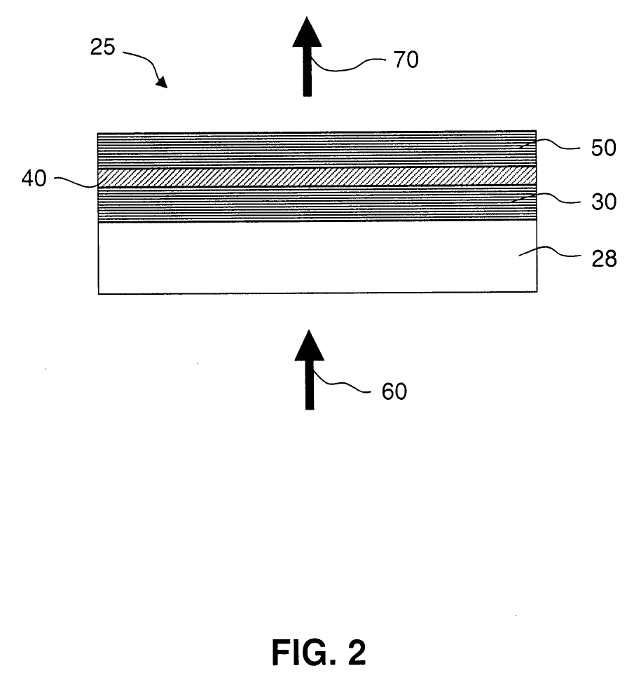

A schematic of a vertical cavity organic laser device 25 is shown in FIG. 2. The substrate 28 can either be light transmissive or opaque, depending on the intended direction of optical pumping or laser emission. Light transmissive substrates 28 may be transparent glass, sapphire, or other transparent flexible materials such as plastic. Alternatively, opaque substrates including, but not limited to, semiconductor material (e.g. silicon) or ceramic material may be used in the case where both optical pumping and emission occur through the same surface. On the substrate is deposited a bottom dielectric stack 30 followed by an organic active region 40. A top dielectric stack 50 is then deposited. A pump beam 60 optically pumps the vertical cavity organic laser device 25. The source of the pump beam 60 may be incoherent, such as emission from a light-emitting diode (LED).

The preferred material for the organic active region 40 is a small-molecular weight organic host-dopant combination typically deposited by high-vacuum thermal evaporation. These host-dopant combinations are advantageous since they result in very small unpumped scattering/absorption losses for the gain media. It is preferred that the organic molecules be of small molecular weight since vacuum deposited materials can be deposited more uniformly than spin-coated polymeric materials. It is also preferred that the host materials used in the present invention are selected such that they have sufficient absorption of the pump beam 60 and are able to transfer a large percentage of their excitation energy to a dopant material via Förster energy transfer. Those skilled in the art are familiar with the concept of Förster energy transfer, which involves a radiationless transfer of energy between the host and dopant molecules. An example of a useful host-dopant combination for red-emitting lasers is aluminum tris(8-hydroxyquinoline) (Alq) as the host and [4-(dicyanomethylene)-2-t-butyl-6-(1,1,7,7-tetramethyljulolidyl-9-enyl)-4H-pyran] (DCJTB) as the dopant (at a volume fraction of 1%). Other host-dopant combinations can be used for other wavelength emissions. For example, in the green a useful combination is Alq as the host and [10-(2-benzothiazolyl)-2,3,6,7-tetrahydro-1,1,7,7-tetramethyl-1H,5H,11H-[1]Benzopyrano[6,7,8-ij]quinolizin-11-one] (C545T) as the dopant (at a volume fraction of 0.5%). Other organic gain region materials can be polymeric substances, e.g., polyphenylenevinylene derivatives, dialkoxy-polyphenylenevinylenes, poly-para-phenylene derivatives, and polyfluorene derivatives, as taught by Wolk et al. in commonly assigned U.S. Pat. No. 6,194,119 B1, issued Feb. 27, 2001, and referenced herein. It is the purpose of the organic active region 40 to receive transmitted pump beam light 60 and emit laser light.

The bottom and top dielectric stacks 30 and 50, respectively, are preferably deposited by conventional electron-beam deposition and can comprise alternating high index and low index dielectric materials, such as, TiO₂ and SiO₂, respectively. Other materials, such as Ta₂O₅ for the high index layers, could be used. The bottom dielectric stack 30 is deposited at a temperature of approximately 240° C. During the top dielectric stack 50 deposition process, the temperature is maintained at around 70° C. to avoid melting the organic active materials. In an alternative embodiment of the present invention, the top dielectric stack is replaced by the deposition of a reflective metal mirror layer. Typical metals are silver or aluminum, which have reflectivities in excess of 90%. In this alternative embodiment, both the pump beam 60 and the laser emission 70 would proceed through the substrate 28. Both the bottom dielectric stack 30 and the top dielectric stack 50 are reflective to laser light over a predetermined range of wavelengths, in accordance with the desired emission wavelength of the laser cavity 25.

The use of a vertical microcavity laser with very high finesse allows a lasing transition at a very low threshold (below 0.1 W/cm² power density). This low threshold enables incoherent optical sources to be used for the pumping instead of the focused output of laser diodes, which is conventionally used in other laser systems. An example of a pump source is a UV LED, or an array of UV LEDs, e.g. from Cree (specifically, the XBRIGHT® 900 UltraViolet Power Chip® LEDs). These sources emit light centered near 405 nm wavelength and are known to produce power densities on the order of 20 W/cm² in chip form. Thus, even taking into account limitations in utilization efficiency due to device packaging and the extended angular emission profile of the LEDs, the LED brightness is sufficient to pump the laser cavity at a level many times above the lasing threshold.

Organic lasers open up a more viable route to output that spans the visible spectrum. Organic based gain materials have the properties of low un-pumped scattering/absorption losses and high quantum efficiencies. VCSEL based organic laser cavities can be optically pumped using an incoherent light source such as light emitting diodes (LED) with lasing power thresholds below 5W/centimetersquared.

One advantage of organic-based lasers is that since the gain material is typically amorphous, devices can be formed inexpensively when compared to lasers with gain materials that require a high degree of crystallinity. Lasers based on amorphous gain materials can be fabricated over large areas without regard to producing large regions of a single crystalline material and can be scaled to arbitrary size resulting in greater power output. Because of the amorphous nature, organic based lasers can be grown on a variety of substrates: thus, materials such as glass, flexible plastics and Si are possible supports for these devices.

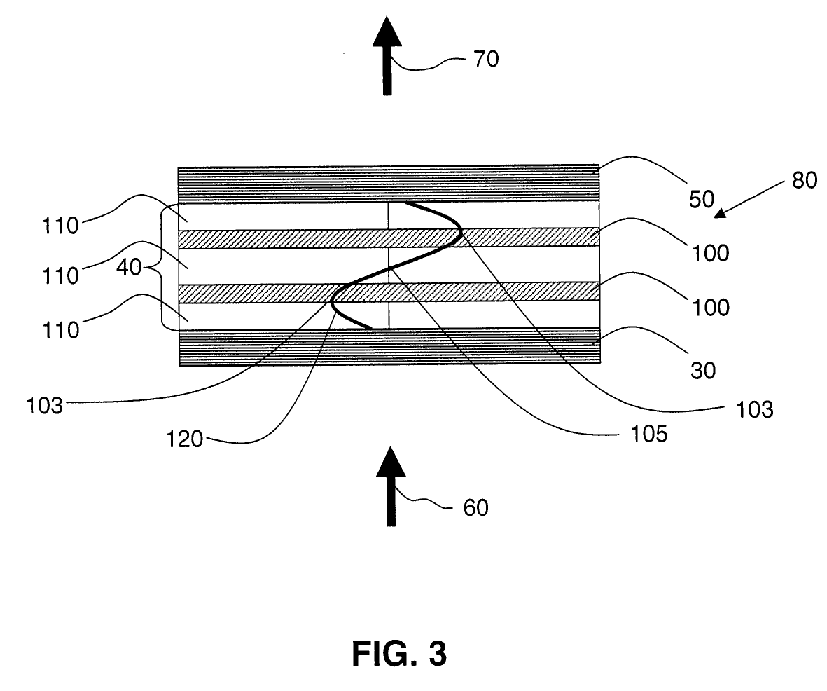

The efficiency of the laser is improved further using an active region design as depicted in FIG. 3 for the vertical cavity organic laser device 80. The organic active region 40 includes one or more periodic gain regions 100 and organic spacer layers 110 disposed on either side of the periodic gain regions 100 and arranged so that the periodic gain regions 100 are aligned with antinodes 103 of the device's standing wave electromagnetic field. This is illustrated in FIG. 3 where the laser's standing electromagnetic field pattern 120 in the organic active region 40 is schematically drawn. Since stimulated emission is highest at the antinodes 103 and negligible at nodes 105 of the electromagnetic field, it is inherently advantageous to form the active region 40. The organic spacer layers 110 do not undergo stimulated or spontaneous emission and largely do not absorb either the laser emission 70 or the pump beam 60 wavelengths. An example of a spacer layer 110 is the organic material 1,1-Bis-(4-bis(4-methyl-phenyl)-amino-phenyl)-cyclohexane (TAPC). TAPC works well as the spacer material since it largely does not absorb either the laser emission 70 or the pump beam 60 energy and, in addition, its refractive index is slightly lower than that of most organic host materials. This refractive index difference is useful since it helps in maximizing the overlap between the electromagnetic field antinodes and the periodic gain region(s) 100. As will be discussed below with reference to the present invention, employing periodic gain region(s) 100 instead of a bulk gain region results in higher power conversion efficiencies and a significant reduction of the unwanted spontaneous emission. The placement of the periodic gain region(s) 100 is determined by using the standard matrix method of optics (Corzine et al. IEEE Journal of Quantum Electronics, Volume 25, No. 6, June 1989). To get good results, the thicknesses of the periodic gain region(s) 100 need to be at or below 50 nm in order to avoid unwanted spontaneous emission.

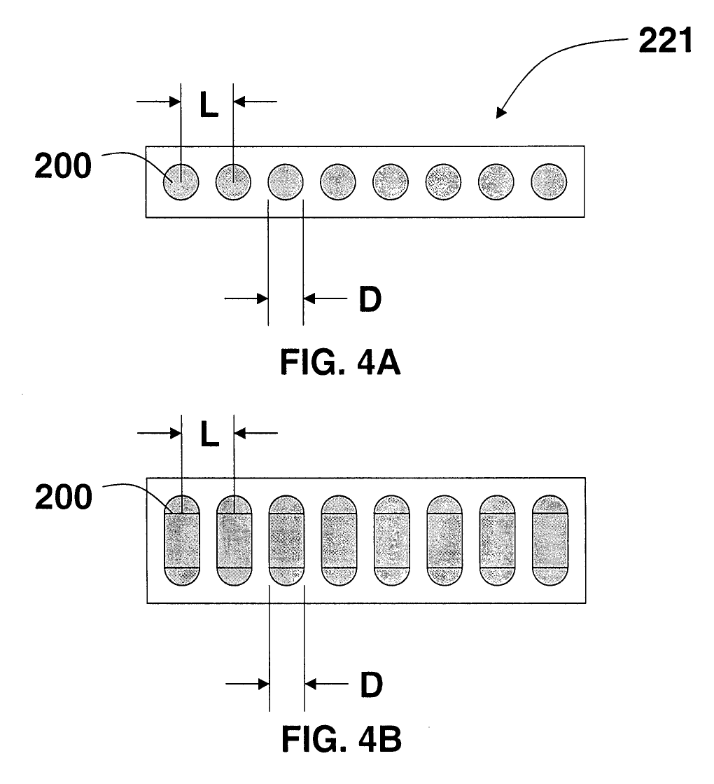

An organic laser cavity structure is a predetermined arrangement of a plurality of organic laser cavity devices 200. FIG. 4A shows a one-dimensional organic laser cavity structure 221. The one-dimensional organic laser cavity structure has a linear arrangement of the organic laser cavity devices 200. It is to be understood that the organic laser cavity devices 200 that comprise elements of the structure can be a variety of shapes, e.g., rectangular, triagonal, etc. other than the circular shapes depicted. An example is shown in FIG. 4B. FIGS. 4A and B are examples of an organic laser cavity structure wherein the arrangement of the organic laser cavity devices 200 is geometrically defined. Geometrically defined means a regular repetition of a pattern. In this case, individual organic laser cavity devices 200 are repeated along the length of the one-dimensional organic laser cavity structure 221.

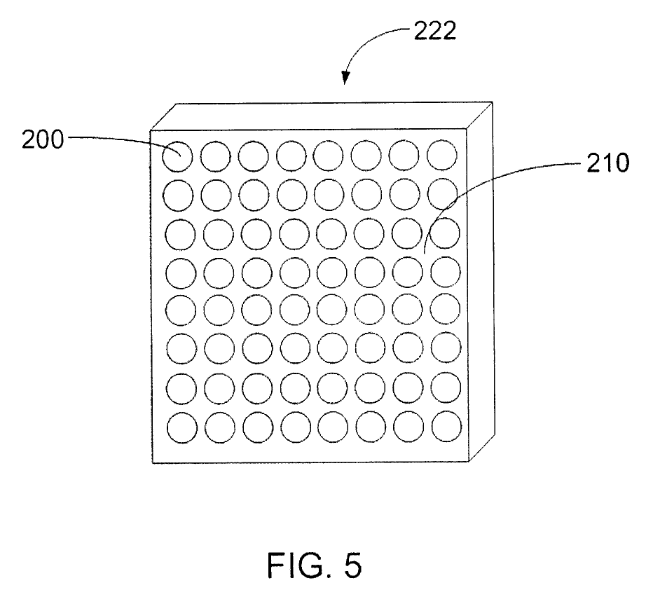

FIG. 5 shows an organic laser cavity structure made in accordance with the present invention in which a two-dimensional arrangement of organic laser cavity devices is depicted. Such a two-dimensional organic laser cavity structure 222 is formed by fabricating organic laser cavity devices 200 in a regular pattern that extends in 2 dimensions. Fabrication of such devices is well known to those who are skilled in the art. The inter-pixel regions 210 generally consist of non-lasing portions of the structure that separate the organic laser cavity devices 200.

Applications of such one-dimensional organic laser cavity structures 221 and two-dimensional organic laser cavity structures 222 include line and area photo-activated printing processes, line and area emissive displays, and the like. The regular repetition of the light emitting organic laser cavity devices 200 as a consequence of the fabrication process produces an exposure device for printing and display applications. The spacing of the organic laser cavity devices 200 in such structures is dictated by the resolution requirements of the application. For example, in a printer application, the organic laser cavity devices 200 may be circular with diameters of approximately 20 to 50 micrometer, while the spacing between such organic laser cavity devices 200 (the inter-pixel regions 210) may be of comparable distances. Although not depicted, an arrangement whereby the diameter of the organic laser cavity devices 200 varies within the array is also considered an embodiment of the present invention.

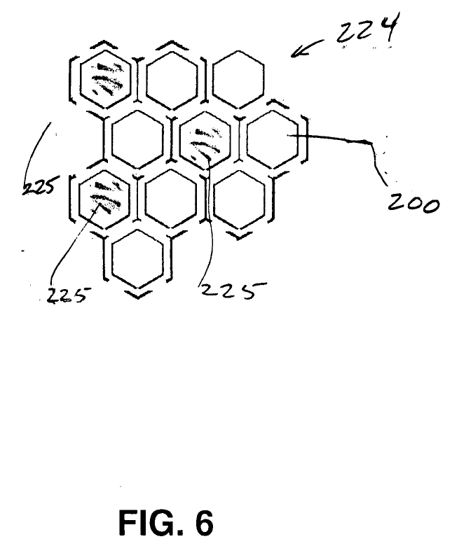

FIG. 6 is a top view schematic of an organic laser cavity structure made in accordance with the present invention in which a two-dimensional hexagonal arrangement of organic laser cavity devices is depicted. Such a hexagonal two-dimensional organic laser cavity structure 224 contains organic laser cavity devices 200 fabricated to produce the closest space-packing array in 2 dimensions. The advantages of such an array include the delivery of optical radiation with high power density. The high power density is achieved from the closest space-packing nature of the hexagonal arrangement. FIG. 6 depicts 3 emitting organic laser cavity devices 225. Other packing arrangements may be implemented.

Referring again to FIG. 4A, the one-dimensional or linear arrangement of organic laser cavity devices 200 is depicted and in which the spatial relationship between organic laser cavity devices 200 is shown. The spatial relations are defined as D=the diameter of the organic laser cavity device 200, and L=the center-to-center distance of separation between the organic laser cavity devices 200. These two parameters can be used to control the output characteristics of the laser light output. For example, for organic laser cavity structures fabricated with organic laser cavity devices 200 designed with substantially identical wavelength outputs, phase-locking of the organic laser cavity devices 200 is strongly dependent upon the parameters D and L. A preferred embodiment for the production of phase-locked laser light output has D=3 to 5 μm and L1=3.25 to 9 μm. As mentioned previously, greater separations of the organic laser cavity devices 200 leads to a loss of phase-locking and decrease of light utilization efficiency, due to the increase in the area between organic laser cavity devices 200. The primary benefit of such phase-locking is that it produces a coherent addition of the optical light power of the individual organic laser cavity devices 200. In this manner, the power output of the organic laser cavity structure can be increased. In some applications, complete incoherence between organic laser cavity devices 200 is desired; each organic laser cavity device 200 acts as an independent laser. In this manner, dissimilar laser light output phases from the organic laser cavity devices 200 could be accomplished. In this case, the independence of the individual organic laser cavity devices 200 can be accomplished by specifying L>9 μm where D=3-5 μm. Of course, it is to be understood that many other combinations of these parameters will also produce the desired output. Similarly, control of the degree of coherence among the elements of such an organic laser cavity structure is not limited to structures of one dimension as is well known to those versed in the art. It is also an embodiment of the current invention to consider organic laser cavity structures wherein phase-locked laser light output sub-structures are created within a larger array of elements where the sub-structures are independent with respect to each other. This design facilitates simultaneously tailoring the output organic laser cavity structure to optimize light power and resolution for a variety of applications. In addition, although circular organic laser cavity devices 200 are depicted in FIG. 4A, other geometric shapes are possible and advantaged in certain applications as shown in FIG. 4B. For example, as discussed in Wilmsen et al., Vertical-Cavity Surface-Emitting Lasers, Cambridge University Press, Cambridge, 2001, rectangular organic laser cavity devices 200 with appropriate dimensions can be used to produce polarized laser light emission from an organic laser cavity structure.

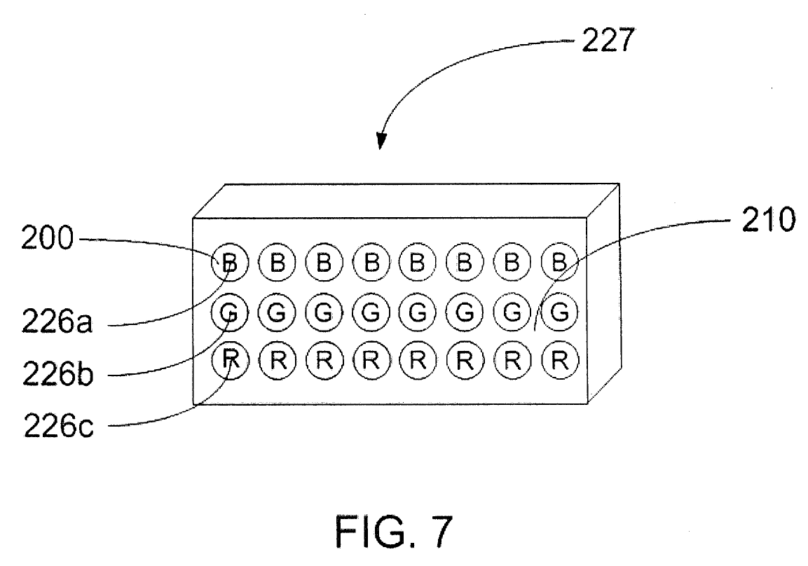

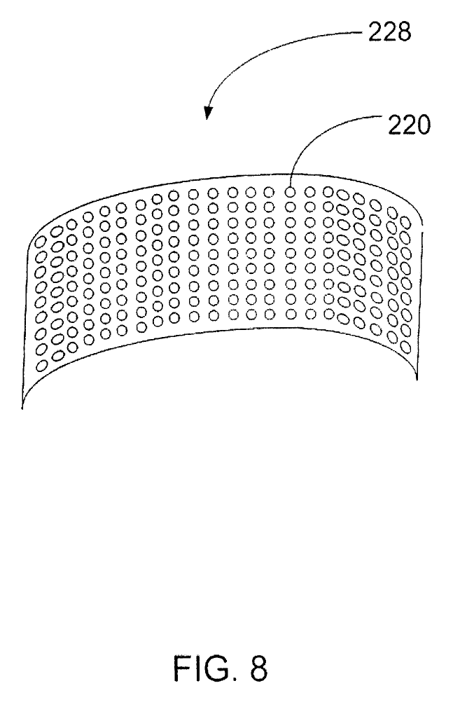

FIG. 7 depicts an organic laser cavity structure in which sub-structures of different wavelength organic laser cavity devices are fabricated. Such a multiwavelength organic laser cavity structure 227 has sub-structures of red (r) 226a, green (g) 226b, and blue (b) 226c regions. As previously discussed, these may be phase-locked with each other, or not, depending on the requirements of the application. The control over the phase locking is obtained by varying the distance parameters displayed in FIG. 4A. FIG. 8 shows an organic laser cavity structure made in accordance with the present invention in which the structure is fabricated on a flexible support. A preferred flexible plastic substrate is a cyclic polyolefin or a polyester. Various cyclic polyolefins are suitable for the flexible plastic substrate. Examples include Arton® made by Japan Synthetic Rubber Co., Tokyo, Japan; Zeanor T made by Zeon Chemicals L.P., Tokyo Japan; and Topas® made by Celanese A. G., Kronberg Germany. Arton is a poly(bis(cyclopentadiene)) condensate that is a film of a polymer. Alternatively, the flexible plastic substrate can be a polyester. A preferred polyester is an aromatic polyester such as Arylite. Although various examples of plastic substrates are set forth above, it should be appreciated that the flexible substrate can also be formed from other materials such as glass and quartz.

Flexible organic laser cavity structures 228 can be produced, because of the relaxed substrate requirements for organic laser cavities as previously mentioned. Such flexible organic laser cavity structures 228 offer many advantages in that the structure can be lightweight and made to conform to a variety of non-planar surfaces. Additionally, the spatial relationship between organic laser cavity devices 200 may be affected by producing such devices on a flexible substrate. In this way the spatial relationship among the plurality of organic laser cavity devices changes with respect to each other. Stretching a flexible substrate may be used to alter the degree of coherence among organic laser cavity devices 200. It is to be understood that any of the organic laser cavity structures features (multiwavelength, control of coherence among elements, etc.) can be realized in combination with flexible organic laser cavity structures 228.

Organic lasers as previously described open up a more viable route to output that spans the visible spectrum. Organic based gain materials have the properties of low unpumped scattering/absorption losses and high quantum efficiencies. VCSEL based organic laser cavities can be optically pumped using an incoherent light source such as light emitting diodes (LED) with lasing power thresholds below 5W/centimeter squared.

One advantage of organic-based lasers is that since the gain material is typically amorphous, devices can be formed inexpensively when compared to lasers with gain materials that require a high degree of crystallinity. Lasers based on amorphous gain materials can be fabricated over large areas without regard to producing large regions of a single crystalline material and can be scaled to arbitrary size resulting in greater power output. Because of the amorphous nature, organic based lasers can be grown on a variety of substrates: thus, materials such as glass, flexible plastics and Si are possible supports for these devices.

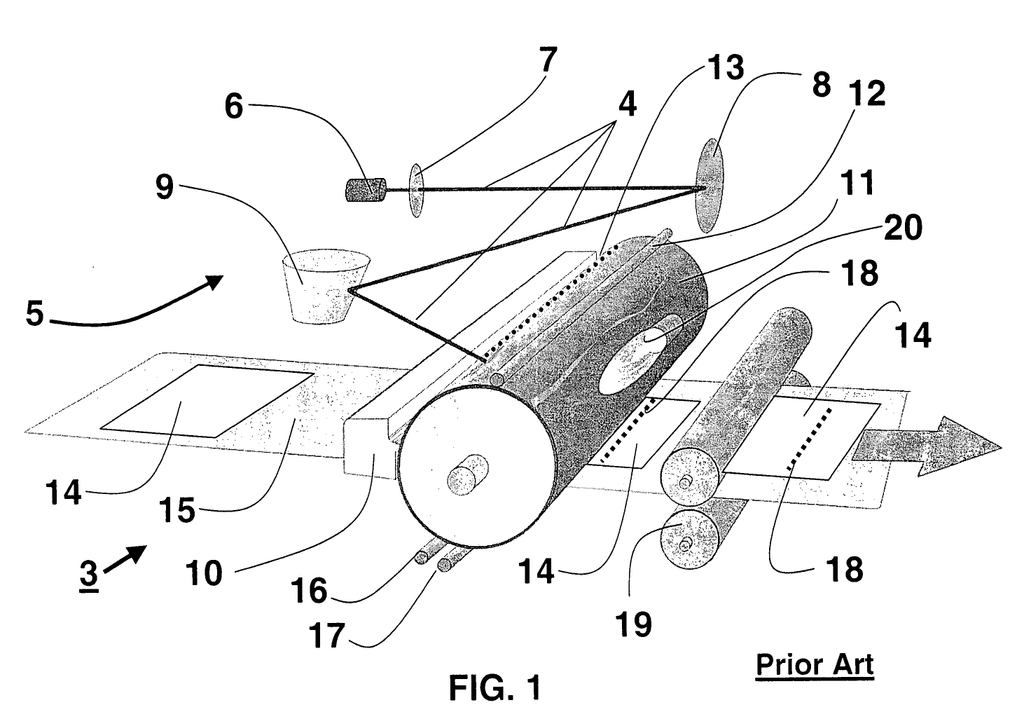

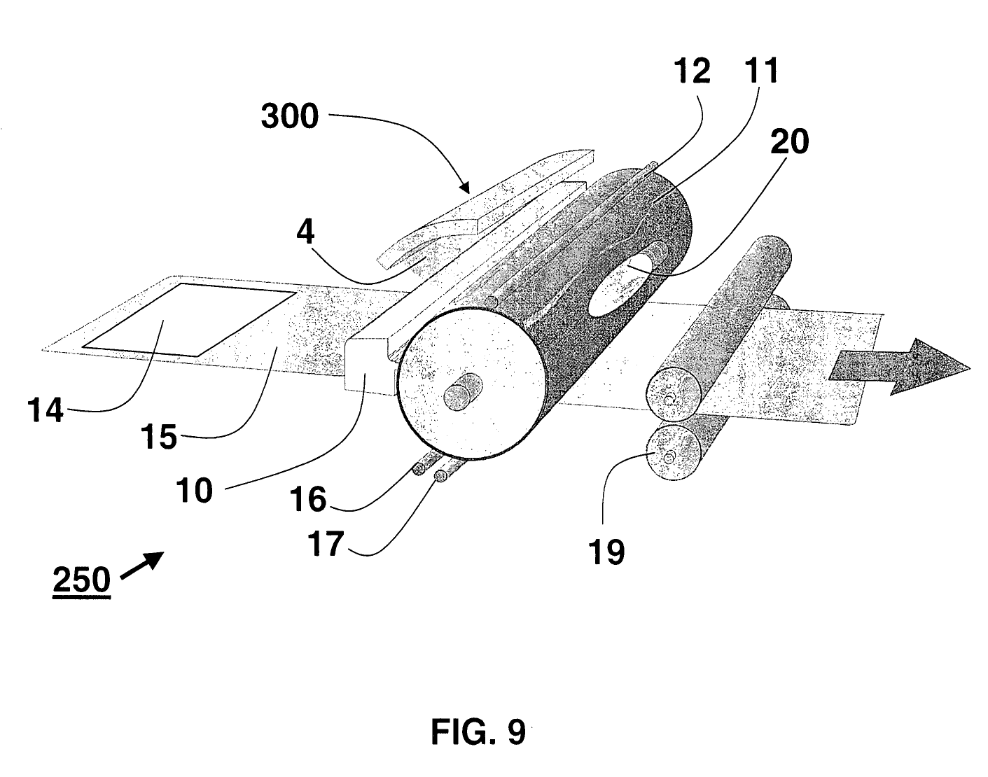

A laser printer 250 comprising an organic laser printer array 300 made in accordance with the present invention is illustrated in FIG. 9. As previously discussed in FIG. 1, like numerals indicate like parts and operations. In one embodiment the organic laser printer array 300 may be removed and replaced as needed. For example in some copiers and printers the toner cartridge and components are recycled when the toner runs out. Likewise the organic laser printer array 300 may be removable and easily recycled because of its low cost.

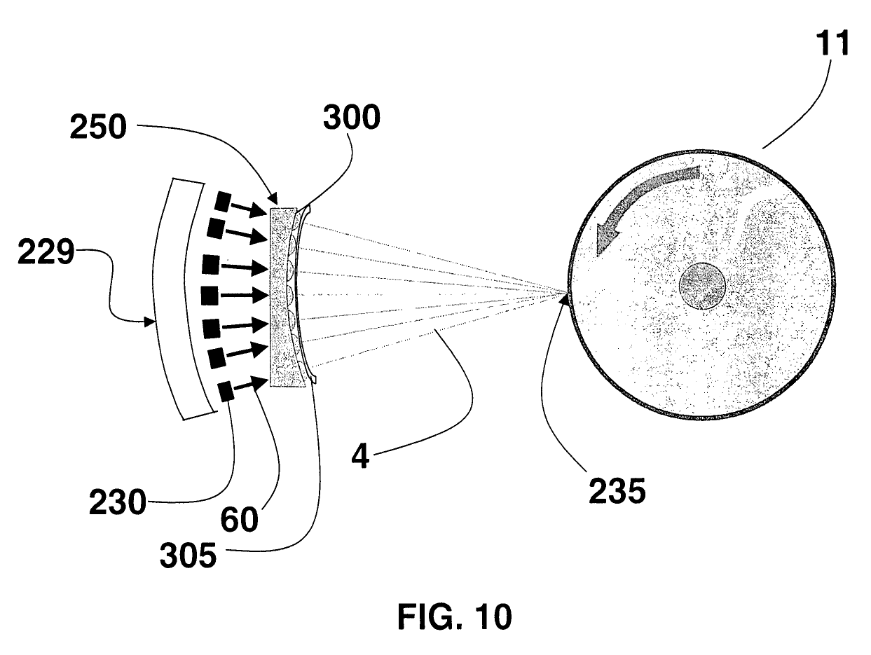

FIG. 10 shows the organic laser cavity structure made in accordance with the present invention in which a light source 229, such as from a plurality of LEDs 230, illuminates the organic laser cavity array structure 300 such as is used in the laser printer 250 of FIG. 9. The LED illuminant 230 is directed at the organic laser cavity structure 300 to optically excite the laser cavities 80. A light shutter layer 305 modulates light emitted from the organic laser cavity structure 300 in order to form an image. In operation, light shutter layer 305 acts as a type of spatial light modulator for illumination emitted by the organic laser cavity structure 300. In this case, the LED illuminant 230 optically pumps a linear printing array organic light cavity structure 300.

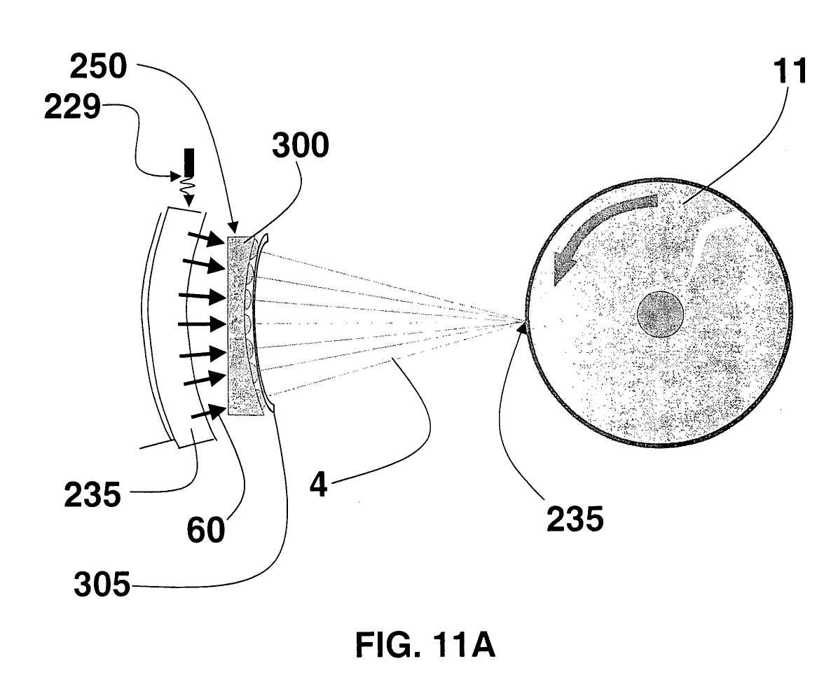

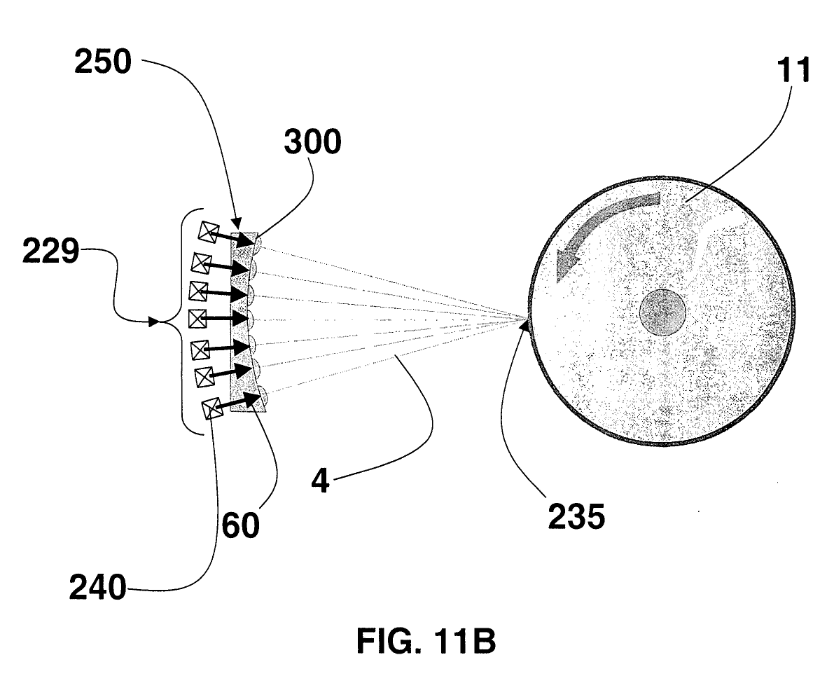

Embodiments of two other light sources 229 are shown in FIGS. 1A and B. As shown in FIG. 1A the light source 229 could be an integrating bar 235 wherein stimulating light for all of the VCSEL based organic laser cavities is supplied simultaneously. In FIG. 11B a light valve 240 at the base of each VCSEL based organic laser cavity is actuated for individual stimulation of a laser cavity 80.

The following equations apply to the organic laser cavity array structure 300 in the laser printer 250:

For a typical laser printer the photoconductive roller needs 1 erg/cm2 to discharge the localized area.
1 erg/cm2=0.01 erg/mm2=1e−9J/mm2
For 2400 dpi printing
Dot size=(25.4/2400)(25.4/2400)=1.2e−4 mm2
Power per dot=energy per dot*area of dot=1.2e−13 J

An embodiment of the proposed arrays would have lasers 10 microns between centers with a diameter of 5 microns per display
Laser area=1/4*pi*d*d=¼*pi*(5e−6)(5e−6)=1.9e−5 mm2
Lasers that make up the area as in EK application number have been found to have laser output/area of 8e−5 W/mm2
The 5 micron lasers described would have laser power=laser power per area*area 8e−5*1.9e−5=1.6e−9 W
Time to process each dot=power per dot/5 micron power=1.2e−13 J/1.6e−9 W=7.5e−5 s or 75 microseconds
Since there is a row of lasers the time to print a page is the number of dots up the page times the time per dot. Dots per page length=26400(2400*11)
TIME PER PAGE˜2 seconds.
By increasing the output of the laser or decreasing the energy needed to discharge the photoconductor printing time could be reduced. Using Organic VCSELs allows the selection of an output wavelength that will require the least amount of energy for a particular photoconductor. Additionally the power incident on the photoreceptor drum could be increased by an array configuration as seen in FIG. 10. Curving the array 300 to focus several lasers 80 on a single spot 235 could allow generation of more power as the power at that spot is the sum of the powers of the individual lasers focused on the spot and would provide redundancy in case any one laser failed, since the failure of one laser would not result in the loss of ability to expose the photoconductive drum 11 at a particular point. This redundancy would result in increased useable lifetime of the device.

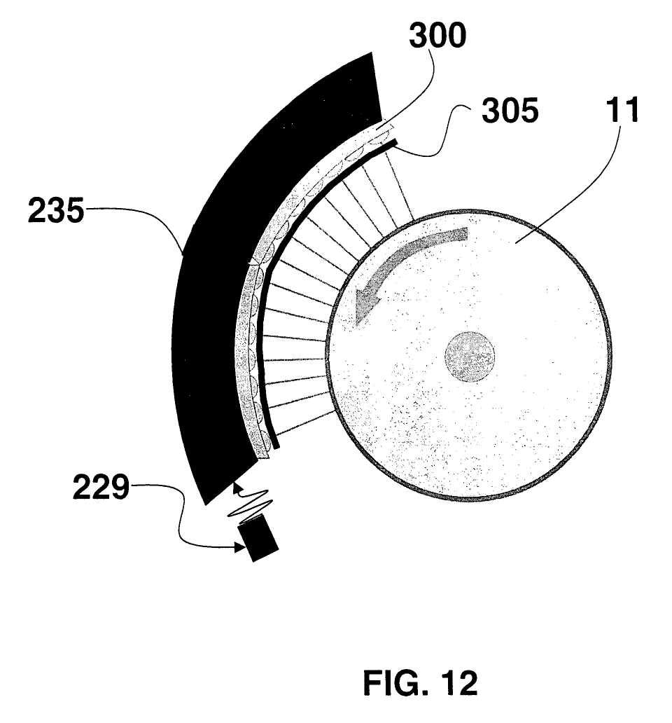

An additional method to reduce printing time is illustrated in FIG. 12. In this embodiment the organic laser printer array 300 is focused on several separate rows of points on the photoconductive drum 11 illuminating each separate row at the same time this increases the speed and the resolution as the roller incrimination becomes larger.

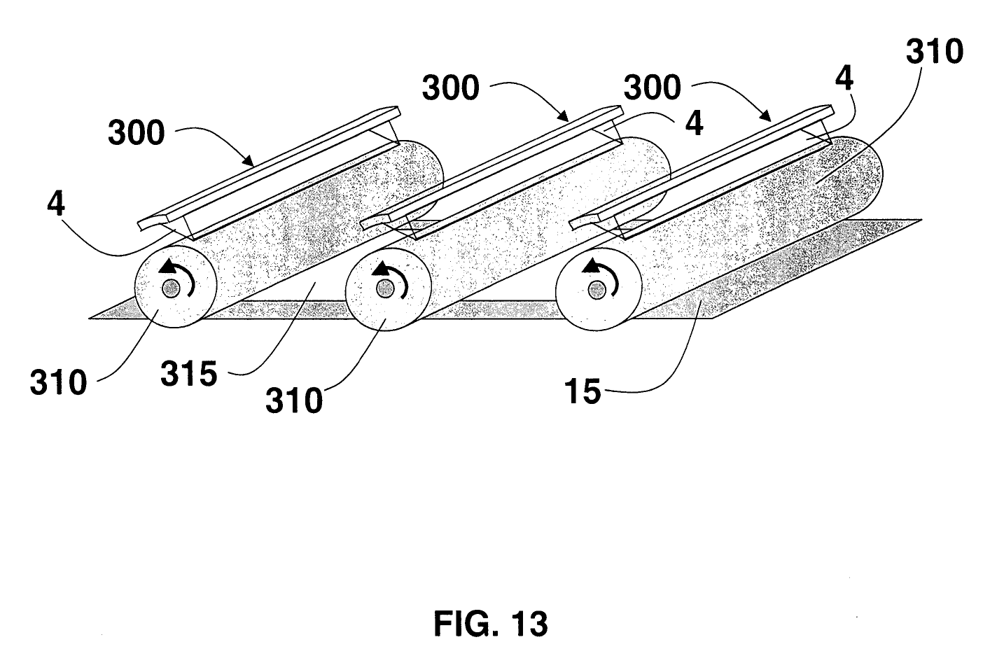

In another embodiment shown in FIG. 13 several photoconductive rollers 310 and laser arrays 300 can be placed in series so that color printing can approach B&W for speed. Using this configuration a web 315 of paper can be printed as well as individual sheets of paper 14.

Electro-photographic printers usually use 780 nm wavelength of light and longer extending into the infrared range. Because of the limitations of the light sources used in electro-photographic printers, photoconductors have been designed to match the light sources. There is a definite advantage inherent in a light source that can be tuned to a variety of wavelengths of visible light such as can be done by the organic VCSELs.

The ability of organic VCSELs to be tuned to specific wavelengths in the range of 430 nanometers to 800 nanometers provides the opportunity to design the organic laser to better match the absorption spectrum of the photoconductor. The matching provides the opportunity to balance the appropriate electron penetration depth. Both of these lead to gains in printing efficiency.

The invention has been described in detail with particular reference to certain preferred embodiments thereof, but it will be understood that variations and modifications can be effected within the spirit and scope of the invention.

### Parts List

3 laser printer
4 laser beam
5 scanner assembly
6 laser
7 collimator lens
8 mirror
9 rotating polygon mirror
10 scanning lens system
11 photo-conductor (drum)
12 charge corona wire
13 pattern
14 paper
15 belt
16 transfer corona wire
17 detach corona wire
18 image pattern
19 fuser
20 discharge lamp
25 vertical cavity organic laser device
28 substrate
30 bottom dielectric stack
40 organic active region
50 top dielectric stack
60 pump beam
70 laser emission
80 vertical cavity organic laser device
100 periodic gain regions
103 antinodes
105 electromagnetic field nodes
110 organic spacer layers
120 electromagnetic field pattern
200 organic laser cavity device
210 inter-pixel regions
220 etched region
221 one-dimensional organic laser cavity structure
222 two-dimensional organic laser cavity structure
224 hexagonal two-dimensional organic laser cavity structure
225 emitting organic laser cavity device
226a, b, c, red, green, blue
227 multiwavelength organic laser cavity structure
228 flexible organic laser cavity structure
229 light source
230 LED illuminate
235 integrating bar
240 light valve
250 laser printer
300 organic laser printer array
305 light shutter layer
310 photoconductive roller

What is claimed is:

1. A printing device, comprising:
a photoconductor for receiving a charge;
a plurality of organic vertical cavity surface emitting lasers for producing a charged image pattern on said photoconductor;
a toner application mechanism for applying a toner onto said photoconductor for creating a toner image pattern in accordance with said charged image pattern; and
a transfer mechanism for transferring said toner image pattern onto a media.

2. The printing device according to claim 1 further comprising a charging mechanism for producing a charge on said photoconductor.

3. The printing device according to claim 1 wherein toner application mechanism is cable of providing a plurality of different color toners onto said photoconductor so as to create a color image on said media.

4. The printing device according to claim 1 wherein said plurality of organic vertical cavity surface emitting lasers are provided in an arranged pattern.

5. The printing device according to claim 4 wherein said arranged pattern comprises a one-dimensional arrangement.

6. The printing device according to claim 5 wherein said one-dimensional arrangement comprises a linear array.

7. The printing device according to claim 4 wherein said arranged pattern comprises a two-dimensional arrangement.

8. The printing device according to claim 5 wherein said two-dimensional arrangement comprises an area array formed of rows and columns.

9. The printing device according to claim 1 further comprising a light source is provided for pumping of the plurality of organic vertical cavity surface emitting lasers.

10. The printing device according to claim 9 wherein a switching mechanism is provided for controlling the exposure of light from said light to each of said plurality of organic vertical cavity surface emitting lasers.

11. The printing device according to claim 1 wherein said plurality of organic vertical cavity surface emitting lasers comprises removable unit.

12. The printing device according to claim 1 wherein said plurality of organic vertical cavity surface emitting lasers emits a light that is designed to substantially match the absorption spectrum of the photoconductor.

13. The printing device according to claim 1 wherein said plurality of organic vertical cavity surface emitting lasers are tuned to wavelengths in the range of 430 nanometers to 800 nanometers.

14. The printing device according to claim 1 wherein said plurality of organic vertical cavity surface emitting lasers comprises an array having a spacing in accordance with the relationships:
D=3 to 5 μm
L=3.25 to 9 μm
wherein D is equal to the diameter of the organic laser cavity laser and L is equal to the center-to-center distance of separation between adjacent organic laser cavity lasers.

15. A method for printing an image onto a media, comprising the steps of:
producing a charged image pattern on a photoconductor using said plurality of organic vertical cavity surface emitting lasers;
applying a toner onto said photoconductor for creating a toner image pattern in accordance with said charged image pattern; and
transferring said toner image pattern onto a media.

16. The method according to claim 15 wherein said plurality of organic vertical cavity surface emitting lasers comprises a plurality of vertical cavity surface emitting lasers.

17. The method according to claim 16 wherein said plurality of organic vertical cavity surface emitting lasers comprises a plurality of vertical cavity surface emitting lasers arranged in a linear array.

18. The method according to claim 17 wherein at least two of said of plurality organic vertical cavity surface emitting lasers are writing onto the same writing spot.

19. The method according to claim 17 wherein said plurality of organic vertical cavity surface emitting lasers are arranged in a two-dimensional array.

20. The method according to claim 19 wherein said two-dimensional array comprises a plurality of rows and columns.

21. The method according to claim 19 wherein at least two of said plurality of organic vertical cavity surface emitting lasers are writing onto the same writing spot.

22. A method for writing an image onto a media, comprising the steps of:
providing a media on which an image is to be created; and
creating said image using a plurality of organic vertical cavity surface emitting lasers.

23. The method according to claim 22 wherein said media comprises a photoconductive surface on which image is written.

24. The method according to claim 22 wherein said media comprises a photographic media.

25. The method according to claim 22 wherein said media comprises a photographic paper.

26. A device for writing onto a media, comprising:
a plurality of organic vertical cavity surface emitting lasers for producing an indicia said media.

27. The device according to claim 26 wherein said media has a photoconductive surface on which indicia is written.

28. The device according to claim 26 wherein said plurality of organic vertical cavity surface emitting lasers are arranged in a linear array.

29. The device according to claim 26 wherein said plurality of organic vertical cavity surface emitting lasers are arranged in a two-dimensional array.

30. The device according to claim 26 wherein at least two of said plurality of organic vertical cavity surface emitting lasers are writing onto the same writing spot.

31. A flexible writing head for writing onto photoconductor, comprising:
a flexible substrate having a plurality of organic vertical cavity surface emitting laser arranged in pattern for producing image on said media.

32. The flexible writing head of claim 32 wherein said substrate comprises a sheet of flexible plastic such as a cyclic polyolefin, polyester or various cyclic polyolefins.

33. The flexible writing head of claim 31 wherein said plurality of organic vertical cavity surface emitting lasers are arranged in a linear array.

34. The flexible writing head of claim 31 wherein said plurality of organic vertical cavity surface emitting lasers are writing onto the same writing spot.

35. The flexible writing head of claim 31 wherein said plurality of vertical cavity surface emitting lasers are arranged in a two-dimensional array.

36. The flexible writing head of claim 35 wherein said two-dimensional array comprises a plurality of rows and columns.

37. The flexible writing head of claim 35 wherein at least two of said plurality of vertical cavity surface emitting lasers are writing onto the same writing spot.

38. A printer for printing onto a media, comprising:
a photoconductor for receiving a charge;
a flexible substrate having a plurality of organic vertical cavity surface emitting lasers provided in an arrangement for producing a charged image pattern on said photoconductor;
a toner application mechanism for applying a toner onto said photoconductor for creating a toner image pattern in accordance with said charged image pattern; and
a transfer mechanism for transferring said toner image pattern onto a media.

39. The printer claim 38 wherein said substrate comprises a sheet of flexible plastic such as a cyclic polyolefin, polyester or various cyclic polyolefins.

40. The printer of claim 38 wherein said plurality of organic vertical cavity surface emitting lasers are arranged in a linear array.

41. The printer of claim 38 wherein at least two of said plurality of organic vertical cavity surface emitting lasers are writing onto the same writing spot.

42. The printer of claim 38 wherein said plurality of vertical cavity surface emitting lasers are arranged in a two-dimensional array.

43. The printer of claim 42 wherein said two-dimensional array comprises a plurality of rows and columns.

44. The printer of claim 42 wherein at least two of said plurality of organic vertical cavity surface emitting lasers are writing onto the same writing spot.
